(19) United States
(12) Patent Application Publication
(10) Pub. No.: US 2015/0039900 A1
(43) Pub. Date: Feb. 5, 2015

(54) PROGRAM EXECUTION METHOD AND DECRYPTION APPARATUS

(71) Applicant: FUJITSU SEMICONDUCTOR LIMITED, Yokohama-shi (JP)

(72) Inventor: Tatsuro KAWAKAMI, Yokohama (JP)

(21) Appl. No.: 14/318,758

(22) Filed: Jun. 30, 2014

(30) Foreign Application Priority Data
Jul. 31, 2013 (JP) 2013-159257

(51) Int. Cl. G06F 21/60; G06F 21/64

(52) U.S. Cl. CPC G06F 21/602; G06F 21/64
USPC 713/187

(57) ABSTRACT

A method for program execution in a system including a decryption apparatus that prevents external referencing and an information processing apparatus communicating therewith and accessing first and third storage areas, includes: the decryption apparatus detecting a series of commands from a command group obtained by decrypting at least a portion of a program stored in the first storage area; obfuscating and storing the series of commands to a second storage area storing the decrypted portion and within the first storage area; assigning, when an execution request is received from the information processing apparatus, the third storage area having a capacity equivalent to any one series of commands; and storing to the third storage area, a series of certain commands stored in the second area and obtained by canceling obfuscation of the commands that correspond to the execution request; and the information processing unit executing the series of certain commands.

### CROSS REFERENCE TO RELATED APPLICATIONS

This application is based upon and claims the benefit of priority of the prior Japanese Patent Application No. 2013-159257, filed on Jul. 31, 2013, the entire contents of which are incorporated herein by reference.

### FIELD

The embodiments discussed herein are related to a program execution method and decryption apparatus.

### BACKGROUND

A conventional apparatus called secure module is connected to an information processing apparatus, decrypts an encrypted program stored in the information processing apparatus at the start of execution, stores a decrypted command group into a storage area of the information processing apparatus, and cancels obfuscation at the time of execution of an obfuscated command in the command group. Related technologies includes, for example, a technique of executing a generation program that generates a scan program by randomly changing a portion of a scan program that scans whether an application under execution is in a secure state (see Japanese Laid-Open Patent Publication No. 2012-038222).

Nonetheless, with the conventional technologies, when an encrypted program is executed, the information processing apparatus stores the encrypted program and a command group obtained by decrypting the encrypted program and, the storage area used in the information apparatus increases compared to an execution of an unencrypted program.

### SUMMARY

According to an aspect of an embodiment, a method for executing a program in a system that includes a decryption apparatus having a structure that prevents external referencing of information stored therein and an information processing apparatus configured to communicate with the decryption apparatus, includes detecting, by the decryption apparatus, a series of commands from a command group obtained by decrypting at least a portion of an encrypted program stored in a first storage area, the first storage area being configured to be accessed by the information processing apparatus; storing, by the decryption apparatus, obfuscated commands to a second storage area that stores a decrypted portion of the encrypted program and is within the first storage area, the obfuscated commands being obtained by obfuscating the detected series of commands; assigning, by the decryption apparatus, when a first execution request of any one series of commands in the command group is received from the information processing apparatus, a third storage area that is different from the first storage area, the third storage area being configured to be accessed by the information processing apparatus and having a storage amount equivalent to the any one series of commands; storing, by the decryption apparatus, to the assigned third storage area, a series of certain commands stored in the second area, the series of certain commands being obtained by canceling obfuscation of the obfuscated commands that correspond to the first execution request; and executing, by the information processing unit, the series of the certain commands stored in the third storage area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are explanatory views of an operation example of a system according to a first embodiment;

FIG. 2 is a block diagram of a hardware configuration example of an information processing apparatus;

FIG. 3 is a block diagram of a hardware configuration example of a secure module;

FIG. 4 is a block diagram of a functional configuration example of the secure module according to the first embodiment;

FIG. 5 is a block diagram of a functional configuration example of the information processing apparatus according to the first embodiment;

FIG. 6 is a sequence chart of operation of the system according to the first embodiment;

FIG. 7 is an explanatory view of an operation example of a preliminary process according to the first embodiment;

FIG. 8 is an explanatory view of an operation example of an activation process according to the first embodiment;

FIG. 9 is an explanatory view of an operation example of an execution process according to the first embodiment;

FIG. 10 is an explanatory view of an example of the contents of a correspondence table of locations of processes calling another subroutine and caller subroutines;

FIG. 11 is a flowchart of an example of an activation process procedure;

FIG. 12 is a flowchart (part one) of an example of an execution process procedure;

FIG. 13 is a flowchart (part two) of an example of the execution process procedure;

FIG. 14 is a block diagram of a functional configuration example of the secure module according to a second embodiment;

FIG. 15 is a block diagram of a functional configuration example of the information processing apparatus according to the second embodiment;

FIG. 16 is an explanatory view of an operation example of the activation process according to the second embodiment;

FIG. 17 is an explanatory view of an operation example of the execution process according to the second embodiment; and

FIG. 18 is an explanatory view of an application example of the first or second embodiment.

### DESCRIPTION OF EMBODIMENTS

Embodiments of a program execution method and a decryption apparatus will be described in detail with reference to the accompanying drawings.

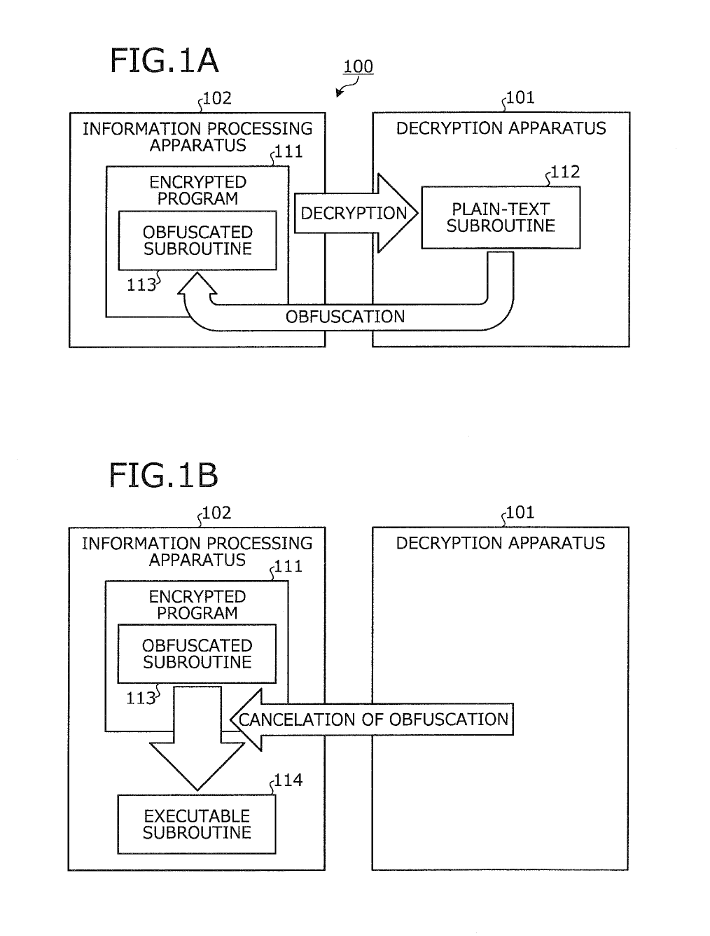

FIGS. 1A and 1B are explanatory views of an operation example of a system according to a first embodiment. A system 100 according to the first embodiment is a system that executes an application while the application is protected against hacking and cracking by a third party. The system 100 includes a decryption apparatus 101 of a structure that prevents external referencing of information stored therein, and an information processing apparatus 102 that is configured to communicate with the decryption apparatus 101 and executes a given application program that is to be protected. An application program will hereinafter be referred to as an “app”.

In the following description, hacking refers to analyzing a program and cracking refers to tampering with a program. A technique of protecting against hacking and cracking by a third party will be described.

For protection against hacking and cracking by a third party, a given app that is to be protected is preliminarily encrypted using a key before distribution and, when the given app is executed, a decryption apparatus having the key decrypts the encrypted app according to an existing technique. As a result, hacking and cracking can be prevented while the given app is not running.

When the given app is activated, the decryption apparatus decrypts the given app and for each activation thereof, changes the sequence or obfuscation of the given app. The decryption apparatus then expands the given app in a main storage device of the information processing apparatus. Consequently, hacking is difficult while the given app is running.

An authentication program that communicates with the decryption apparatus is generated by an existing technique to have contents that periodically differ. A process of requesting the authentication program to perform authentication is embedded in the given app and obfuscation of an obfuscated portion of the given app is temporarily canceled and put into an executable state by the decryption apparatus if the authentication is successful and at the moment of execution of the obfuscated portion in an existing technique. As a result, even if a third party dumps the contents on the main storage device of the information processing apparatus while the given app is running, the dumped contents are inoperable.

However, since the decryption apparatus decrypts the given app and, changes the sequence or obfuscation of the given app, a storage area for storing the encrypted given app is established along with a storage area for storing the given app after a changing of the sequence. To indicate the obfuscated portion, the developer of the given app must embed the process of requesting the authentication, which requires extra labor.

Therefore, the system 100 according to the present embodiment sequentially decrypts the given app, obfuscates a detected subroutine to overwrite a decrypted portion, cancels the obfuscation of the subroutine requested to be executed, and stores the subroutine into an area different from the area storing the given app. As a result, the system 100 can reduce the storage area used at the time of execution of the given app. The system 100 according to the present embodiment eliminates the need for explicitly specifying an obfuscated portion and therefore, the labor of the developer can be reduced.

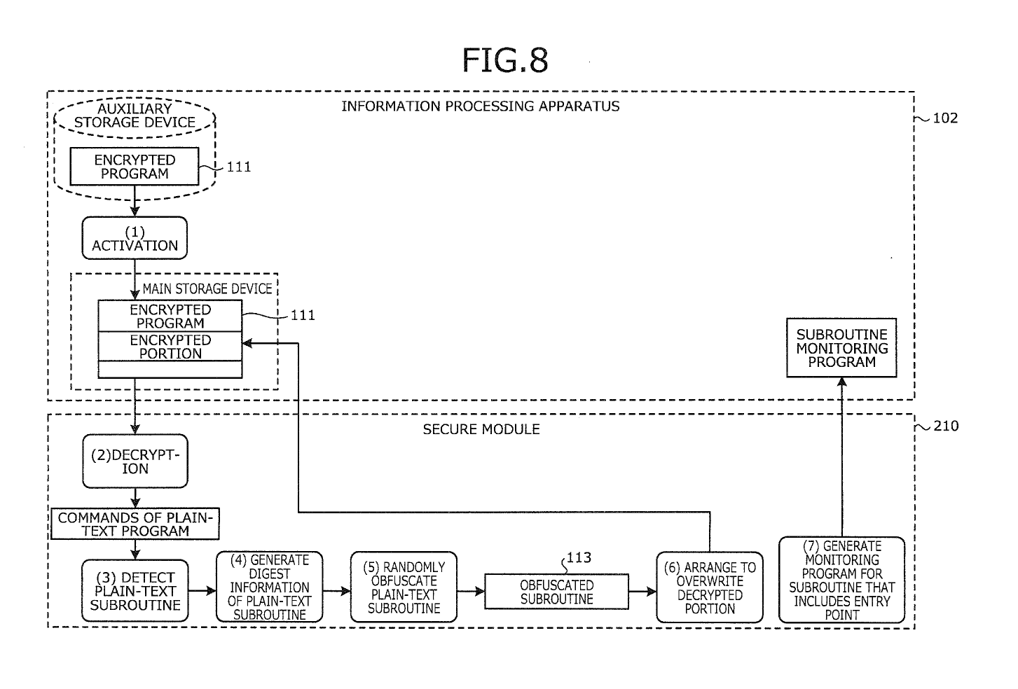

In FIG. 1A, the decryption apparatus 101 decrypts a portion of or an entire encrypted program 111 that is stored in a first storage area that can be accessed by the information processing apparatus 102. The decryption apparatus 101 detects a series of commands from a command group obtained by the decryption. The series of commands is multiple commands collected based on meaning or contents. The series of commands is, for example, a subroutine or a main routine that calls a subroutine. In the following description, it is assumed that a main routine is a kind of a subroutine and that the series of commands is a subroutine. A method of detecting a subroutine will be described later with reference to FIG. 8.

The decryption apparatus 101 then obfuscates a detected plain-text subroutine 112. The decryption apparatus 101 stores a subroutine that is obfuscated, i.e., an obfuscated subroutine 113, into a second storage area that stores a decrypted portion of the encrypted program 111 and is within the first storage area.

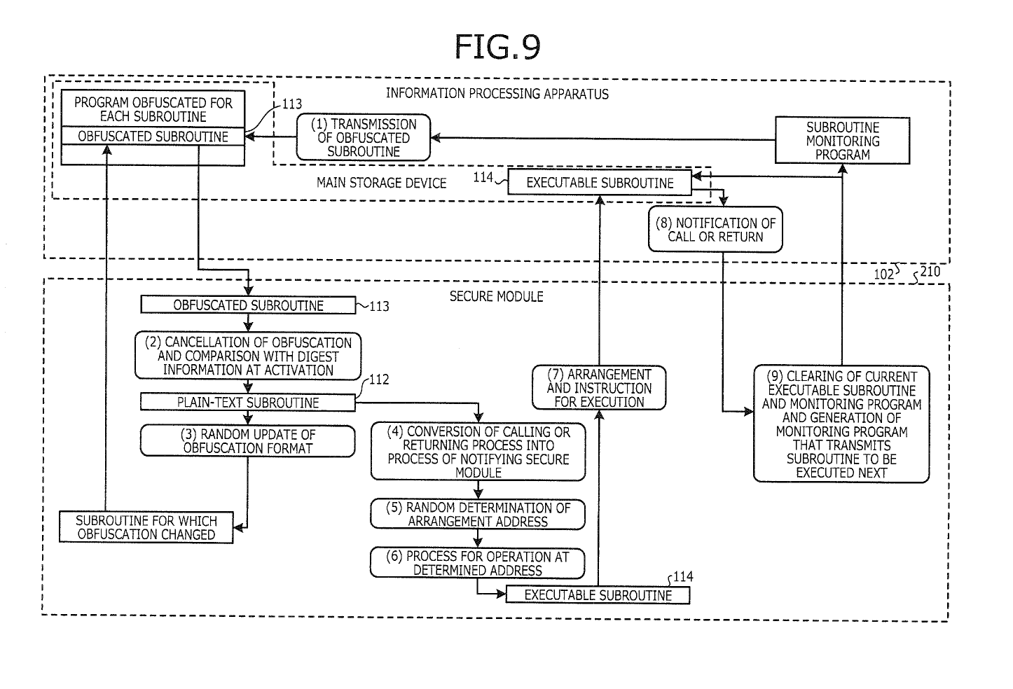

In FIG. 1B, if an execution request for a subroutine among a subroutine group is received from the information processing apparatus 102, the decryption apparatus 101 assigns a third storage area. The decryption apparatus 101 stores into the third storage area, a subroutine obtained by canceling the obfuscation of the obfuscated subroutine 113 that corresponds to the execution request. When storing the subroutine into the third storage area, the decryption apparatus 101 processes the subroutine such that the subroutine becomes executable in the third storage area. A subroutine processed to be executable will be referred to as an “executable subroutine”. A specific process example will be described later with reference to FIG. 9.

The third storage area can be accessed by the information processing apparatus and has a storage amount for a subroutine that corresponds to the execution request and is different from the first storage area. After storing an executable subroutine 114, the information processing apparatus 102 executes the executable subroutine 114. The information processing apparatus 102 suffices to establish the first storage area of a storage amount for the encrypted program and the third storage area of a storage area for one subroutine. The system 100 will hereinafter be described.

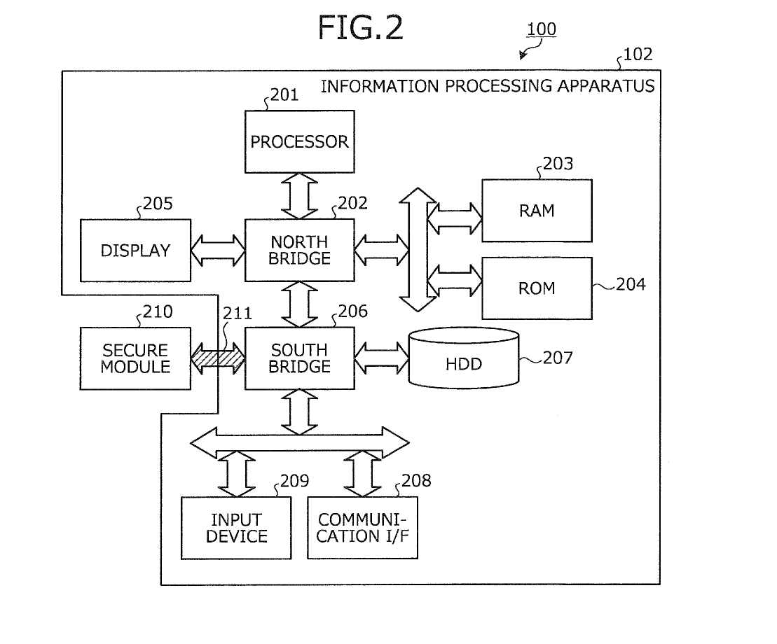

FIG. 2 is a block diagram of a hardware configuration example of the information processing apparatus. The information processing apparatus 102 has a processor 201, a north bridge 202, memory, a display 205, a south bridge 206, a hard disk drive (HDD) 207, a communication interface (I/F) 208, and an input device 209, respectively connected through a bus. The information processing apparatus 102 is connected to a secure module 210. The secure module 210 corresponds to the decryption apparatus 101.

The processor 201 is a device that provides control and executes a calculation process in the information processing apparatus 102. The north bridge 202 is a device connected to and thus bridges the processor 201, the memory (random access memory (RAM) 203, read only memory (ROM) 204), the display 205, and the south bridge 206. The RAM 203 is main memory used as a work area of the processor 201. The ROM 204 is non-volatile memory that stores programs and data. The display 205 is a device that displays a cursor, icons, and tool boxes, as well as data such as documents, images, and function information.

The south bridge 206 is connected to and thus bridges the north bridge 202, the HDD 207, the communication I/F 208, the input device 209, and the secure module 210. The HDD 207 is a drive device that, under the control of the processor 210, controls the reading and writing of data with respect to a built-in hard disk.

The communication I/F 208 is an interface that is configured to enable connection to a network such as a local area network (LAN), a wide area network (WAN), and the Internet through a communication line under the control of the south bridge 206.

The input device 209 is a device for inputting text, numeric characters, and various instructions. For example, the input device 209 may be a keyboard, a mouse, and a touch panel. Input data from the input device 209 is sent through the south bridge 206 and the north bridge 202 to the processor 201 and is processed by the processor 201.

The secure module 210 is a large-scale integration (LSI) of a structure that prevents external referencing of information stored therein and is hardware that prevents peeking from the outside and preventing tampering of internal data. The structure that prevents external referencing of information stored therein may be a tamper resistant module (TRM) structure, for example.

The TRM structure refers to structure for physically and logically defending a semiconductor chip etc., from internal analysis and tampering. For example, the secure module 210 has a strong, highly-adhesive coating applied to the inside and, if the surface of the coating is peeled, an internal circuit is completely destroyed or dummy wirings are arranged.

The secure module 210 is communicably connected via a bus 211 to a controller in the south bridge 206. The secure module 210 may be built into the information processing apparatus 102 or may externally be arranged.

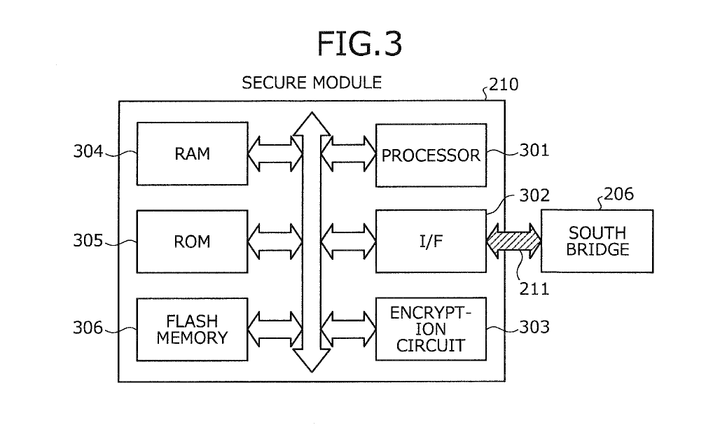

FIG. 3 is a block diagram of a hardware configuration example of the secure module. The secure module 210 has a processor 301, an I/F 302, an encryption circuit 303, RAM 305, ROM 305, and flash memory 306.

The processor 301 is a device that provides control and executes a calculation process in the secure module 210. The I/F 302 is a device connected via the bus 211 to the controller in the south bridge 206 to perform communication. The encryption circuit 303 is a device that encrypts data and programs, decrypts encrypted data and programs, obfuscates decrypted data and programs, and cancels obfuscation of obfuscated data and programs.

The RAM 304 is maim memory used as a work are of the processor 301. The ROM 305 is non-volatile memory that stores programs and data. The flash memory 306 is non-volatile memory in which stored data and programs can be rewritten.

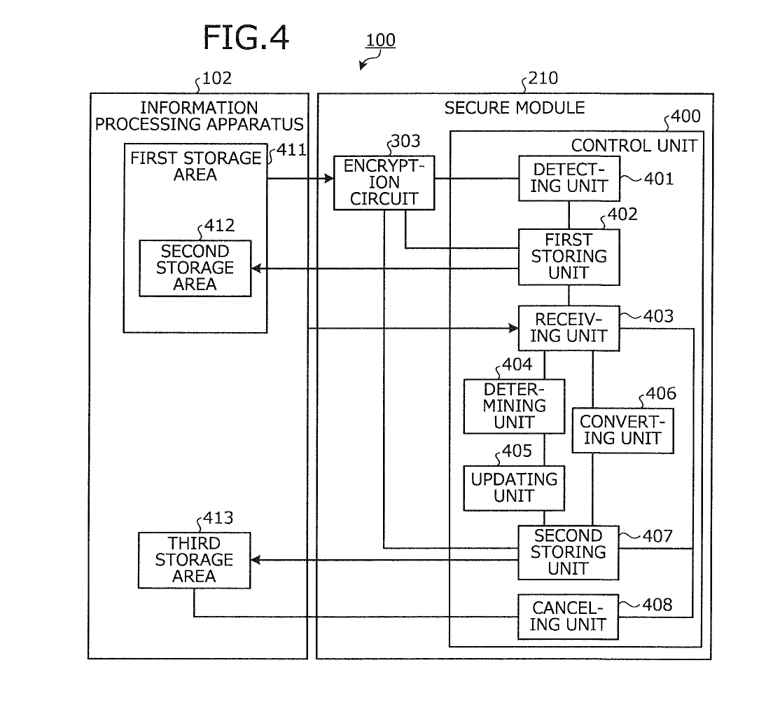

FIG. 4 is a block diagram of a functional configuration example of the secure module according to the first embodiment. The secure module 210 includes the encryption circuit 303 and a control unit 400. The control unit 400 includes a detecting unit 401, a first storing unit 402, a receiving unit 403, a determining unit 404, an updating unit 405, a converting unit 406, a second storing unit 407, and a canceling unit 408. With regard to the control unit 400, the function of the control unit 400 is implemented by executing on the processor 301, a program stored in a storage device. For example, the storage device is the RAM 304 and the ROM 305 depicted in FIG. 3. The output results of the detecting unit 401 to the canceling unit 408 are stored to a storage area of the secure module 210.

The secure module 210 is configured to access a first storage area 411, a second storage area 412, and a third storage area 413. The first storage area 411, the second storage area 412, and the third storage area 413 are established in the RAM 203.

The first storage area 411 can be accessed by the information processing apparatus 102 and is a storage area that stores the encrypted program 111.

The second storage area 412 is a storage area that stores a decrypted portion of the encrypted program 111 and is within the first storage area 411.

The third storage area 413 can be accessed by the information processing apparatus 102 and has a storage amount for a subroutine that corresponds to an execution request and is different from the first storage area 411.

The detecting unit 401 detects the plain-text subroutine 112 from the command group obtained when the encryption circuit 303 decrypts a portion of or the entire encrypted program 111 stored in the first storage area, which can be access by the information processing apparatus 102.

The first storing unit 402 stores into the second storage area 412, the obfuscated subroutine 113, which is a subroutine detected by the detecting unit 401 and obfuscated by the encryption circuit 303. For example, it is assumed that the detecting unit 401 detects a first plain-text subroutine and successively detects a second plain-text subroutine from the command group obtained by decrypting the encrypted program 111 from the beginning.

In this case, for example, the first storing unit 402 stores an obfuscated subroutine that corresponds to the first plain-text subroutine using a storage area starting from the beginning of the first storage area 411 as the second storage area 412 and successively stores an obfuscated subroutine that corresponds to the second plain-text subroutine. Alternatively, the first storing unit 402 may store the obfuscated subroutine that corresponds to the second plain-text subroutine using a storage area starting from the beginning of the first storage area 411 as the second storage area 412 and may successively store the obfuscated subroutine that corresponds to the first plain-text subroutine.

The first storing unit 402 may store into the second storage area 412, an obfuscated command obtained by obfuscating a detected subroutine according to any obfuscation format randomly selected from among multiple obfuscation formats. The multiple obfuscation formats are, for example, encryption, bit swapping, and calculation processes such as XOR. If encryption is selected as the obfuscation format, the first storing unit 402 also randomly selects a key for the encryption. Similarly, if bit swap is selected as the obfuscation format, the first storing unit 402 randomly selects a bit pattern indicative of which bit is swapped with which bit. Similarly, if XOR is selected as the obfuscation format, the first storing unit 402 randomly selects a mask pattern used in the XOR. The selected obfuscation format is stored in a storage area of the secure module 210 correlated with the subroutine.

When the receiving unit 403 receives an execution request, the first storing unit 402 may store into the second storage area 412, the obfuscated subroutine 113 obtained by obfuscating the subroutine that corresponds to the execution request, according to any newly randomly selected obfuscation format.

The first storing unit 402 may retain digest information of a subroutine detected by the detecting unit 401, correlated with the subroutine.

The receiving unit 403 receives an execution request from the information processing apparatus 102. The received execution request is stored to a storage area of the secure module 210.

When an execution request is received from the information processing apparatus 102, the determining unit 404 randomly determines an address of the third storage area from a predetermined address range. The predetermined address range is an address range determined in advance when the given app that is to be protected is activated.

The updating unit 405 updates based on the address determined by the determining unit 404, a command that uses a relative address or an absolute address and is in the plain-text subroutine 112 obtained when the encryption circuit 303 cancels the obfuscation of the obfuscated subroutine corresponding to the execution request. For example, it is assumed that the plain-text subroutine 112 includes a command that uses a relative address as an offset address of 0x100 from the beginning and causes a jump to 0x10 from the address indicated by the command. It is also assumed that the address determined by the determining unit 404 is 0x1000. In this case, the updating unit 405 updates the command described above to a command that uses an absolute address to cause a jump to 0x10+0x100+0x1000=0x1110.

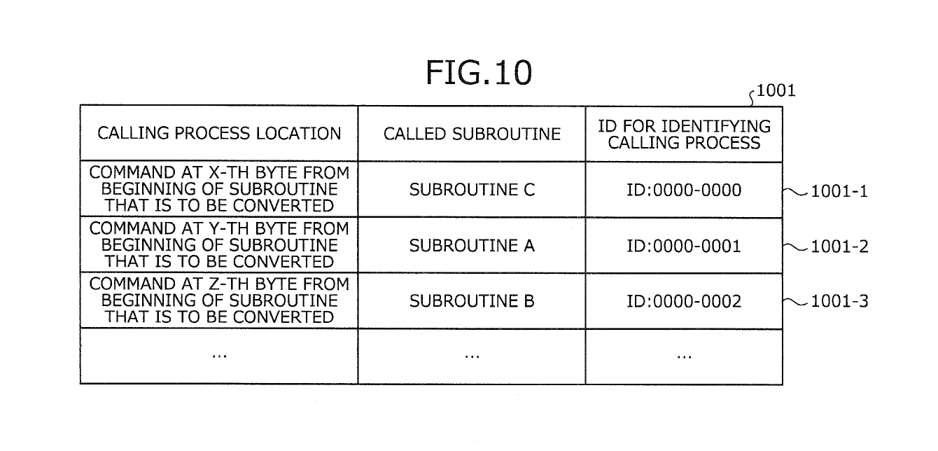

When the receiving unit 403 receives the execution request, the converting unit 406 converts a command for calling another subroutine different from the subroutine among the plain-text subroutines 112 that correspond to the execution request, into a command for notifying the secure module 210 of an execution request for another subroutine. The converting unit 406 also converts a command for returning to a subroutine that is a caller of a subroutine among the plain-text subroutines 112 that correspond to the execution request into a command for notifying the secure module 210 of an execution request of the subroutine that is the caller. Conversion will be described later with reference to FIGS. 9 and 10.

If an execution request for a subroutine of the command group is received from the information processing apparatus 102, the second storing unit 407 assigns the third storage area 413. The second storing unit 407 stores into the third storage area 413, the executable subroutine 114 that corresponds to the execution request stored in the second storage area 412.

If an execution request is received from the information processing apparatus 102, the second storing unit 407 assigns the third storage area 413. The second storing unit 407 may store into the third storage area 413, the executable subroutine 114 obtained when the encryption circuit 303 cancels according to the obfuscation format, the obfuscation of the obfuscated command that corresponds to the execution request.

The second storing unit 407 may store into the assigned third storage area 413, the executable subroutine 114 updated by the updating unit 405. The second storing unit 407 may store into the assigned third storage area 413, the executable subroutine 114 converted by the converting unit 406.

If an execution request is received from the information processing apparatus 102, the second storing unit 407 determines whether the digest information of the plain-text subroutine 112 that corresponds to the execution request stored in the second storage area is identical to the digest information retained by the first storing unit 402. If it is determined that the digest information are not identical, the second storing unit 407 does not store into the third storage area 413, the executable subroutine 114 obtained by cancelling the obfuscation of the obfuscated command that corresponds to the execution request. Alternatively, if it is determined that the digest information are not identical, configuration may be such that the second storing unit 407 does not assign the third storage area 413.

The second storing unit 407 determines whether an execution request for a subroutine has been received from the information processing apparatus 102 before a predetermined time interval has elapsed since the time of receipt of an execution request for a caller command that is a caller of a subroutine, from the information processing apparatus 102. It is assumed that after it has been determined that no execution request for a subroutine has been received from the information processing apparatus 102 before the predetermined time interval has elapsed, the second storing unit 407 receives an execution request for a command that calls a subroutine. When an execution request for a command that calls a subroutine is received, the second storing unit 407 does not store into the third storage area 413, the subroutine obtained by cancelling the obfuscation of the obfuscated command that corresponds to the execution request. When an execution request for a command that calls a subroutine is received, configuration may be such that the second storing unit 407 does not assign the third storage area 413.

If an execution request for another subroutine different from a subroutine called by any of the subroutines is received from the information processing apparatus 102, the canceling unit 408 cancels the assignment of the third storage area 413.

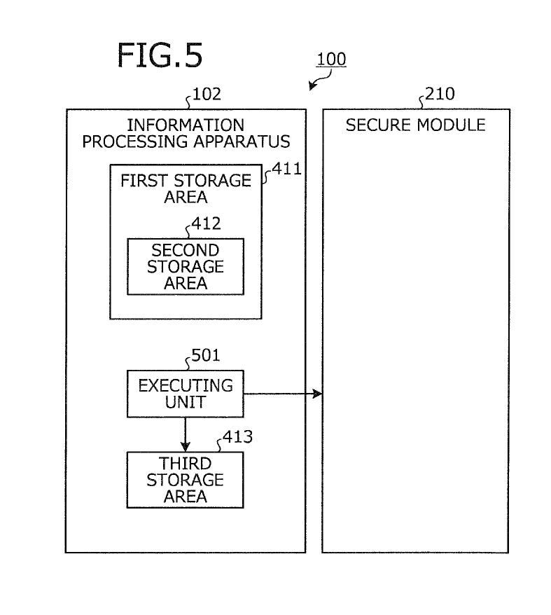

FIG. 5 is a block diagram of a functional configuration example of the information processing apparatus according to the first embodiment. The information processing apparatus 102 has an executing unit 501. The executing unit 501 corresponds to the processor 201. The information processing apparatus 102 is configured to access the first storage area 411, the second storage area 412, and the third storage area 413.

The executing unit 501 executes the executable subroutine 114 stored in the third storage area 413. Since the executable subroutine 114 includes a command for notifying the secure module 210 of an execution request for another subroutine, when the command is executed, the executing unit 501 notifies the secure module 210 of the execution request for another subroutine.

A program execution method according to the present embodiment will be described as three separate steps, i.e., a preliminary process, an activation process, and an execution process. The preliminary process is a process in the development and distribution of a given app that is to be protected and the installation of the given app. The activation process is a process at the activation of the given app. The execution process is a process during operation of the given app.

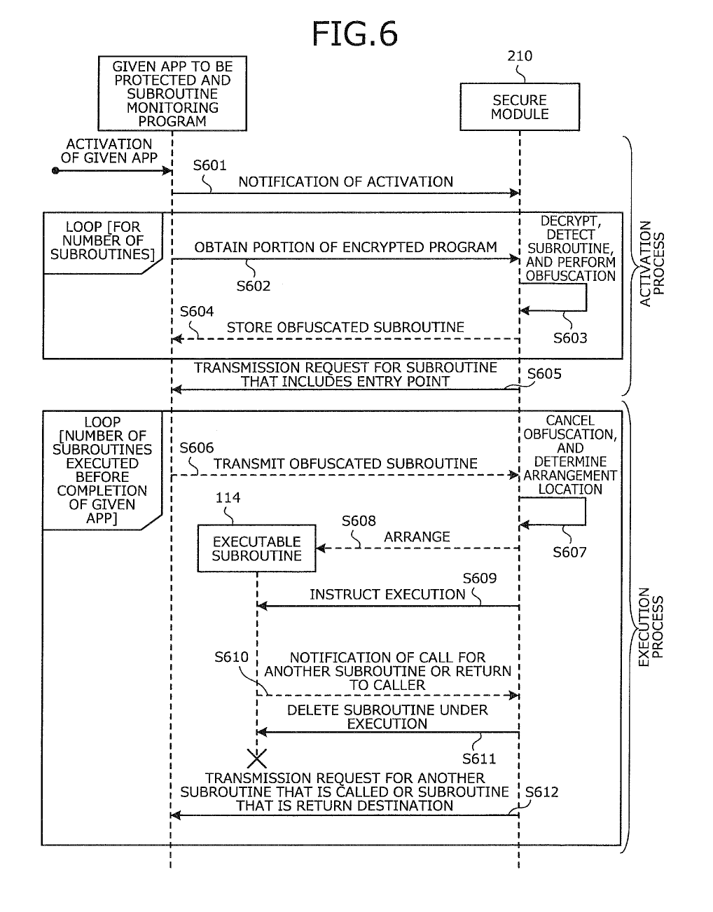

FIG. 6 is a sequence chart of operation of the system according to the first embodiment. FIG. 6 is the sequence diagram related to the activation process and the execution process. In the sequence diagram depicted in FIG. 6, steps S601 to S605 are steps related to the activation process. In the sequence diagram depicted in FIG. 6, steps S606 to S612 are steps related to the execution process.

When receiving, consequent to a user instruction, an activation request for a given app that is to be protected, the information processing apparatus 102 notifies the secure module 210 of activation of the given app (step S601). The notified secure module 210 obtains a portion of the encrypted program 111 generated by encrypting the given app (step S602). The secure module 210 then decrypts the obtained portion, detects a subroutine, and performs obfuscation for each subroutine (step S603).

The secure module 210 stores the obfuscated subroutine 113 subjected to the obfuscation (step S604). The secure module 210 repeats steps S602 to S604 for the number of subroutines. The secure module 210 notifies the information processing apparatus 102 of a transmission request for a subroutine that includes an entry point (step S605). For example, the secure module 210 generates a monitoring program for a subroutine executed by the information processing apparatus 102 and thereby, transmits to the information processing apparatus 102, the transmission request for a subroutine that includes an entry point.

The monitoring program then transmits the obfuscated subroutine 113 to the secure module 210 (step S606). The secure module 210 receives the obfuscated subroutine 113, cancels the obfuscation, and randomly determines an arrangement location (step S607). The secure module 210 arranges at the determined arrangement location, the subroutine with the obfuscation canceled (step S608). The secure module 210 instructs the information processing apparatus 102 to execute the arranged subroutine (step S609).

The information processing apparatus 102 receives the instruction for execution and during execution of the subroutine, executes a command embedded in the subroutine and thereby, notifies the secure module 210 of a call for another subroutine or a return to a caller (step S610). The notified secure module 210 deletes the subroutine under execution (step S611). The secure module 210 then notifies the information processing apparatus 102 of a transmission request for another subroutine that is called or a subroutine that is a return destination (step S612). For example, the secure module 210 generates a monitoring program for a subroutine executed by the information processing apparatus 102 and thereby, transmits the transmission request for another subroutine that is called or a subroutine that is a return destination.

The information processing apparatus 102 and the secure module 210 repeat the operations at steps S606 to S612 for the total number of the subroutines executed before completion of the given app that is to be protected. For example, it is assumed that the information processing apparatus 102 activates the given app, executes a subroutine A, executes a subroutine B during execution of the subroutine A, returns to the subroutine after the subroutine B is terminated, terminates the subroutine A, and terminates the given app. In this case, the total number of the subroutines executed before termination of the given app is three.

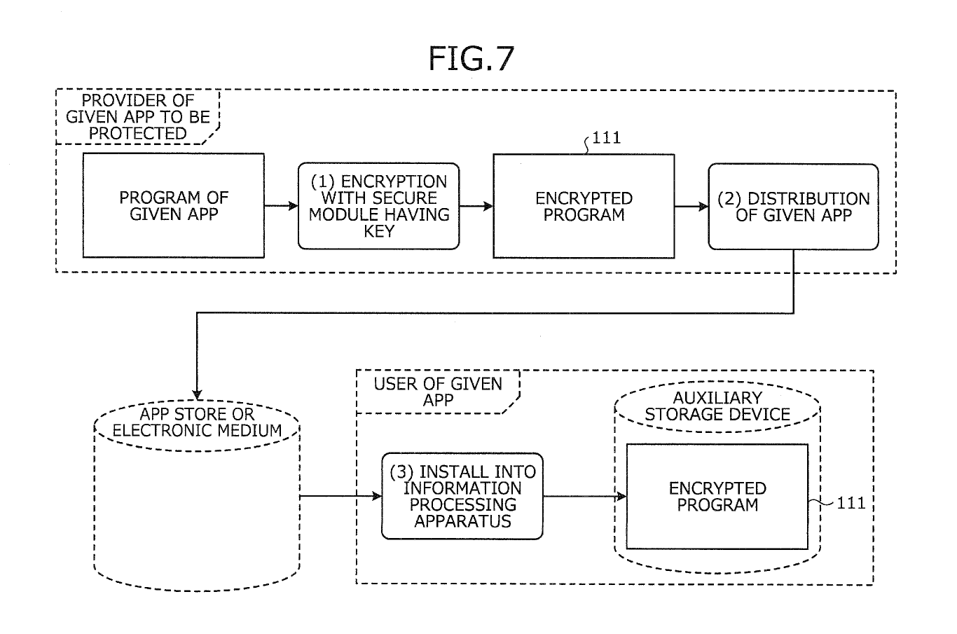

FIG. 7 is an explanatory view of an operation example of the preliminary process according to the first embodiment. At (1) of FIG. 7, after program development of a given app that is to be protected, an operation by the developer providing the given app causes an apparatus operated by a developer to encrypt the given app with a key included in a secure module. A result of the encryption is the encrypted program 111. An operation by the developer also causes the apparatus operated by the developer to set a predetermined time interval until the given app is considered stopped because of a break made by a third party during operation of the given app.

At (2) of FIG. 7, when the given app is distributed, the apparatus operated by the developer distributes the given app encrypted, through registration to an app store or transmission as an electronic medium.

At (3) of FIG. 7, with regard to the installation of the given app, an information processing apparatus operated by a user stores the given app encrypted into an auxiliary storage device of the information processing apparatus 102 such as the HDD 207. The information processing apparatus 102 stores the encrypted program 111 into non-volatile memory so as to prevent hacking or cracking of the contents of the auxiliary storage device when the given app is not running.

FIG. 8 is an explanatory view of an operation example of the activation process according to the first embodiment. At (1) of FIG. 8, when the given app that is to be protected is activated, the information processing apparatus 102 reads out the encrypted program 111 (obtained by encrypting the given app) from the auxiliary storage device such as the HDD 207 to a main storage device such as the RAM 203.

At (2) of FIG. 8, the secure module 210 reads and decrypts each portion of the encrypted program 111, from the beginning of the encrypted program 111. A decryption result forms commands of a plain-text program. At (3) of FIG. 8, the secure module 210 detects the plain-text subroutine 112 from the commands. In a detection method, the secure module 210 searches for a process of saving to a stack, a value of a register implemented at a subroutine entry or a process of returning from a stack, a value of a register implemented at a subroutine entry and thereby, detects the plain-text subroutine 112. When detecting the plain-text subroutine 112, the secure module 210 stores the entry point, if an entry point exists. The entry point is stored to a program header, for example.

At (4) of FIG. 8, the secure module 210 generates digest information for the plain-text subroutine 112. For example, the secure module 210 inputs the plain-text subroutine 112 to a hash function such as Secure Hash Algorithm (SHA)-256 to generate the digest information for the plain-text subroutine 112.

At (5) of FIG. 8, the secure module 210 obfuscates the plain-text subroutine 112 by using an obfuscation format randomly selected from multiple obfuscation formats. As a result of the obfuscation, the obfuscated subroutine 113 is generated.

The secure module 210 correlates and stores into a storage area of the secure module 210, a random combination of the digest information that is for the plain-text subroutine 112 and generated at (4) of FIG. 8 and the obfuscation performed at (5) of FIG. 8, and the identification information of the plain-text subroutine 112. The identification information of the plain-text subroutine 112 is a leading address of the plain-text subroutine 112.

At (6) of FIG. 8, the secure module 210 arranges the obfuscated subroutine 113 in the main storage device, overwriting the storage area storing the decrypted portion of the encrypted program 111. Consequent to the overwriting, a data amount at the time of encryption is preferably identical to a data amount at the time of decryption. An encryption algorithm without an increase in data amount at the time of encryption may be Advanced Encryption Standard (AES)-Cipher Clock Chaining (CBC)+Output Feedback (OFB), for example.

If a portion of the encrypted program 111 is not yet decrypted, the secure module 210 repeats the operation from (2) of FIG. 8. After completion of the obfuscation, at (7) of FIG. 8, the secure module 210 generates a subroutine monitoring program for monitoring a subroutine that includes an entry point of the given app. The information processing apparatus 102 executes the subroutine monitoring program. The information processing apparatus 102 can arrange the obfuscated given app on the main storage device to make it difficult to hack the contents on the main storage device while the given app is running.

FIG. 9 is an explanatory view of an operation example of the execution process according to the first embodiment. At (1) of FIG. 9, the information processing apparatus 102 uses the subroutine monitoring program to refer to the obfuscated subroutine 113 to be executed and transmits the obfuscated subroutine 113 to the secure module 210. The obfuscated subroutine 113 to be executed is a subroutine that includes an entry point at a first session and is a subroutine to which a calling request is made from a subroutine from a second session on.

At (2) of FIG. 9, the secure module 210 cancels the obfuscation of the obfuscated subroutine 113 to obtain the plain-text subroutine 112, generates the digest information for the plain-text subroutine 112, and makes a comparison to determine whether the digest information is identical to the digest information stored in the activation process. As a result, the secure module 210 can detect tampering of the obfuscated subroutine 113 in operation. If not identical, the secure module 210 considers that the obfuscated subroutine 113 has been cracked, and does not execute a subsequent process.

At (3) of FIG. 9, the secure module 210 obfuscates the plain-text subroutine 112 by using an obfuscation format randomly selected from multiple obfuscation formats. The secure module 210 updates the obfuscated subroutine 113 on the main storage device with the subroutine changed in obfuscation.

At (4) of FIG. 9, the secure module 210 converts all the processes of calling another subroutine in the plain-text subroutine 112 into processes of notifying the secure module 210 of a call. The secure module 210 converts a process of returning to a caller, subroutine in the plain-text subroutine 112 into a process of notifying the secure module 210 of a return. At the time of the conversion, the secure module 210 stores a correspondence table of the locations of the processes of calling another subroutine and the caller subroutines so as to identify which subroutine a calling process is executed for when the calling process is executed in the plain-text subroutine 112. The correspondence table will be described later with reference to FIG. 10. The secure module 210 performs the conversion of the calling processes through operation of jump destination addresses of a call command and a branch command. The secure module 210 performs the conversion of the return processes through operation of a register and a stack retaining a return address.

At (5) of FIG. 9, the secure module 210 randomly determines an arrangement address of the converted plain-text subroutine 112, from a predetermined address range. At (6) of FIG. 9, the secure module 210 processes the converted plain-text subroutine 112 such that plain-text subroutine 112 is operated at the determined address rather than an address other than the determined address. For example, the secure module 210 changes a command that uses a relative address or an absolute address into a command that uses an absolute address from the determined address. The plain-text subroutine 112 made executable by changing the addresses will hereinafter be considered as the executable subroutine 114.

At (7) of FIG. 9, the secure module 210 arranges the executable subroutine 114 in the assigned third storage area 413 of the main storage device and instructs the information processing apparatus 102 to execute the executable subroutine 114. The secure module 210 gives the instruction for execution by setting into a program counter of the information processing apparatus 102, the address of the command to be executed next in the arranged subroutine.

At (8) of FIG. 9, during execution of the executable subroutine 114, with the calling of another subroutine or a return to the caller subroutine, the information processing apparatus 102 notifies the secure module 210 of a change of subroutine. In the case of the calling another subroutine, the information processing apparatus 102 also notifies of the secure module 210 of information that indicates “identification (ID) for specifying which calling process”.

At (9) of FIG. 9, the secure module 210 notified of a change of subroutine clears the current executable subroutine 114 in the main storage device of the information processing apparatus 102 and the subroutine monitoring program. For example, the secure module 210 cancels the assignment of the third storage area 413 storing the executable subroutine 114. The secure module 210 generates a monitoring program that transmits the subroutine to be executed next. The information processing apparatus 102 repeats the operation from (1) of FIG. 9.

In the case of the calling another subroutine, the secure module 210 refers to the correspondence table depicted in FIG. 10 and uses the “ID for specifying which calling process” to determine the subroutine to be executed next. The secure module 210 stores which subroutine is the current executable subroutine 114 acting as a caller, into a storage area of the secure module 210, in a stacked manner. On the other hand, in the case of the returning to the caller subroutine, the secure module 210 determines the last stored caller subroutine as the subroutine to be executed next. The secure module 210 removes the last stored caller subroutine from the stack type storage area.

If no notification of a change of subroutine is made even when the predetermined time interval set at the time of program development has elapsed, the secure module 210 considers that a break has been made by a third party, and does not execute a subsequent process.

At (2) of FIG. 9, the secure module 210 compares the digest information between the plain-text subroutine 112 obtained by canceling the obfuscation and the plain-text subroutine 112 at the time of activation. As a result, the secure module 210 can detect cracking of the contents on the main storage device of the information processing apparatus 102.

At (3) of FIG. 9, the secure module 210 randomly updates for each execution of a subroutine, calculation and a key for the obfuscation of the obfuscated subroutine 113 on the main storage device of the information processing apparatus 102. As a result, the secure module 210 can make it difficult to hack the contents on the main storage device of the information processing apparatus 102. The secure module 210 prevents contents dumped on the main storage device from running.

At (5) of FIG. 9, the secure module 210 sets a storage amount of program arranged on the main storage device of the information processing apparatus 102 to one subroutine at the same time and randomizes the arrangement location of the executable subroutine 114. As a result, the secure module 210 prevents contents dumped on the main storage device of the information processing apparatus 102 from running. For example, if a third party performs the dumping for a given address, since the arrangement location of the executable subroutine 114 is randomized, the executable subroutine 114 is unlikely to be arranged at the given address and the third party is more likely to be unable to obtain the executable subroutine 114. Even if the third party performs the dumping for a given address and can obtain a portion of the executable subroutine 114, since the executable subroutine 114 is randomized, the remaining portion of the executable subroutine 114 is difficult to obtain.

The secure module 210 monitors whether a time interval of the calling and the returning to subroutine is within the predetermined time interval set at the time of program development. As a result, the secure module 210 can detect that a brake has been made in the given app that is to be protected.

FIG. 10 is an explanatory view of an example of the contents of the correspondence table of the locations of the processes calling another subroutine and the caller subroutines. A correspondence table 1001 depicted in FIG. 10 has records 1001-1 to 1001-3. The correspondence table 1001 has three fields, respectively for a calling process location, a called subroutine, and an ID for identifying a calling process.

The calling process location is stored as information that indicates what number of the bytes from the beginning corresponds to a command that is a code for another subroutine in a series of commands defined as a subroutine that is to be converted, when the plain-text subroutine 112 of (4) of FIG. 9 is the subroutine that is to be converted. The called subroutine is stored as identification information of another subroutine called by the command specified by the calling process location. The ID for specifying a calling process is stored as an ID for identifying the calling process location. The secure module 210 adds information of the “ID for specifying which calling process” to each process of notifying the secure module 210 of a call from the information processing apparatus 102.

For example, the record 1001-1 indicates that a command at an X-th byte from the beginning is a command for calling a subroutine C in a series of the commands defined as the subroutine that is to be converted. The record 1001-1 also indicates that if ID:0000-0000 is added to the process of notifying the secure module 210 of a call, the secure module 210 considers that the execution request for the subroutine C is received and executes the process of (9) of FIG. 9.

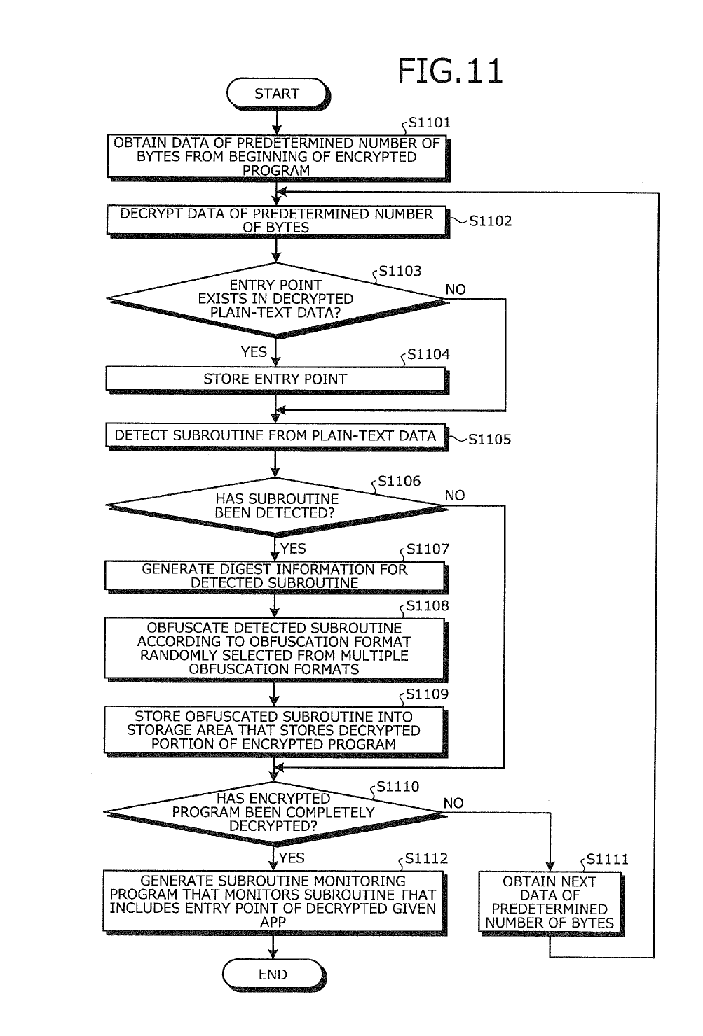

FIG. 11 is a flowchart of an example of an activation process procedure. The activation process is a process executed when the given app that is to be protected is activated. The activation process is executed when the information processing apparatus 102 makes a notification of activation of the given app that is to be protected.

The secure module 210 obtains data of the predetermined number of bytes from the beginning of the encrypted program 111 (step S1101). The secure module 210 decrypts the data of the predetermined number of bytes (step S1102). The secure module 210 then determines whether an entry point exists in the decrypted plain-text data (step S1103). If an entry point exists in the decrypted plain-text data (step S1103: YES), the secure module 210 stores the entry point to a storage area of the secure module 210 (step S1104).

After completion of the operation at step S1104 or if no entry point exists in the decrypted plain-text data (step S1103: NO), the secure module 210 detects a subroutine from the plain-text data (step S1105). The secure module 210 then determines whether a subroutine has been detected (step S1106). If a subroutine has been detected (step S1106: YES), the secure module 210 generates digest information for the detected subroutine (step S1107). The secure module 210 then obfuscates the detected subroutine according to an obfuscation format randomly selected from multiple obfuscation formats (step S1108). The secure module 210 then stores the obfuscated subroutine into a storage area that stores the decrypted portion of the encrypted program 111 and is within the storage area that stores the encrypted program 111 (step S1109).

After completion of the operation at step S1109 or if no subroutine is detected (step S1106: NO), the secure module 210 determines whether the encrypted program 111 has been completely decrypted (step S1110). If a portion of the encrypted program 111 has not yet been decrypted (step S1110: NO), the secure module 210 obtains the next data of the predetermined number of bytes (step S1111). After completion of the operation at step S1111, the secure module 210 goes to the operation at step S1102.

If the encrypted program 111 is completely decrypted (step S1110: YES), the secure module 210 generates a subroutine monitoring program that monitors a subroutine that includes the entry point of the decrypted given app that is to be protected (step S1112). After completion of the operation at step S1112, the secure module 210 terminates the activation process. By executing the activation process, the secure module 210 can make preparations for making it difficult for a third party to obtain information when the given app is activated.

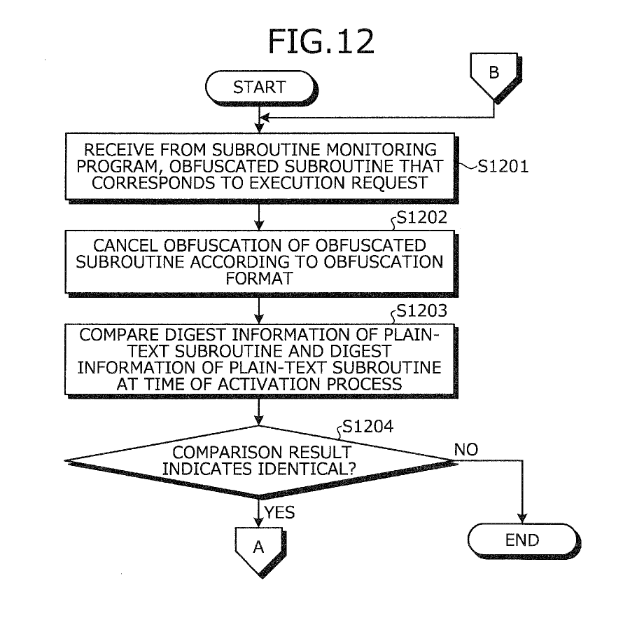

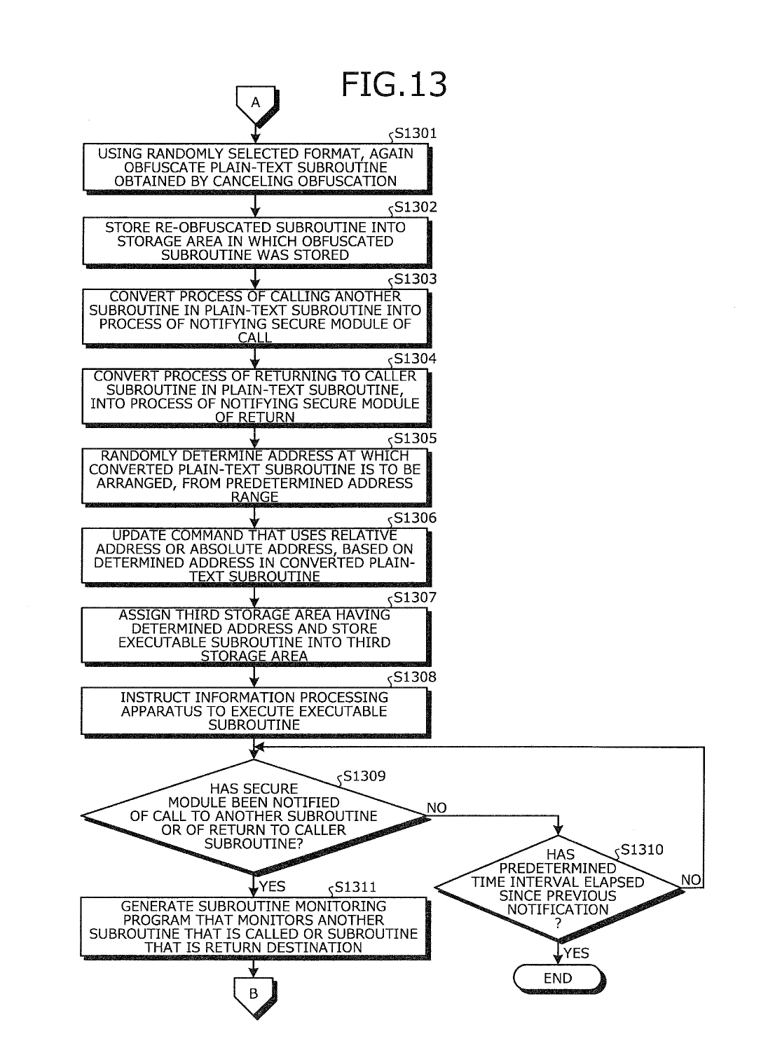

FIG. 12 is a flowchart (part one) of an example of an execution process procedure. FIG. 13 is a flowchart (part two) of an example of the execution process procedure. The execution process is a process of making it difficult for a third party to obtain a subroutine when the information processing apparatus 102 executes the subroutine.

In FIG. 12, the secure module 210 receives from a subroutine monitoring program, an obfuscated subroutine that corresponds to an execution request (step S1201). The subroutine monitoring program is the subroutine monitoring program generated by the operation at step S1112 of FIG. 11 or an operation at step S1311 of FIG. 13 described later.

The secure module 210 cancels the obfuscation of the obfuscated subroutine according to the obfuscation format (step S1202). The secure module 210 compares the digest information of the plain-text subroutine 112 and the digest information of the plain-text subroutine 112 at the time of the activation process (step S1203).

The secure module 210 determines whether the comparison result indicates identical (step S1204). If the comparison result does not indicate identical (step S1204: NO), the secure module 210 considers that an unintended change has occurred in the obfuscated subroutine, and terminates the execution process. If the comparison result indicates identical (step S1204: YES), the secure module 210 executes an operation at step S1301 depicted in FIG. 13.

In the case of step S1204: YES, according to an obfuscation format randomly selected from multiple obfuscation formats, the secure module 210 again obfuscates the plain-text subroutine 112 obtained by canceling the obfuscation (step S1301). The secure module 210 stores the re-obfuscated subroutine into the storage area in which the obfuscated subroutine has been stored (step S1302).

The secure module 210 converts a process of calling another subroutine in the plain-text subroutine 112 into a process of notifying the secure module of a call (step S1303). The secure module 210 converts a process of returning to a caller subroutine in the plain-text subroutine 112, into a process of notifying the secure module of a return (step S1304).

The secure module 210 then randomly determines an address at which the converted plain-text subroutine 112 is to be arranged, from the predetermined address range (step S1305). The secure module 210 updates a command that uses a relative address or an absolute address, based on the determined address in the converted plain-text subroutine 112 (step S1306). The secure module 210 assigns the third storage area 413 having the determined address and stores the executable subroutine 114 into the third storage area 413 (step S1307). The secure module 210 instructs the information processing apparatus to execute the executable subroutine 114 (step S1308).

The secure module 210 determines whether the secure module 210 has been notified of a call to another subroutine or of a return to a caller subroutine by the system 100 (step S1309). If the secure module 210 has not been notified of a call to another subroutine or of a return to a caller subroutine (step S1309: NO), the secure module 210 determines whether the predetermined time interval has elapsed since the previous notification (step S1310). If the predetermined time interval has elapsed (step S1310: YES), the secure module 210 considers that unintended suspension occurs in the executable subroutine 114 due to a break, and terminates the execution process. If the predetermined time interval has not elapsed (step S1310: NO), the secure module 210 goes to the operation at step S1309.

If the secure module 210 has been notified of a call to another subroutine or of a return to a caller subroutine (step S1309: YES), the secure module 210 generates a subroutine monitoring program that monitors another subroutine that is called or a subroutine that is a return destination (step S1311). After completion of the operation at step S1311, the secure module 210 goes to the operation at step S1201. By executing the execution process, the secure module 210 can make it difficult for a third party to obtain a subroutine when the information processing apparatus 102 executes the subroutine.

As described, the secure module 210 sequentially decrypts the given app that is to be protected, obfuscates a detected subroutine to overwrite a decrypted portion, cancels the obfuscation of only the subroutine requested to be executed, and stores the subroutine into an area different from the first storage area 411. As a result, the system 100 can reduce the amount of the storage area used at the time of execution of the given app. In a method of embedding a location of obfuscation into a portion of the given app that is to be protected, the location of obfuscation must explicitly be specified in program development. For the monitoring during operation and the cancelation of obfuscation, a developer must create processes of calling a monitoring program and an authentication program within the given app in program development. Therefore, as the number of obfuscation locations increases, the development cost generated for protecting the program increases. In the system 100 according to the present embodiment, the cost required for protection does not increase even when a size of the given app that is to be protected becomes larger.

If an execution request for another subroutine called from a subroutine is received from the information processing apparatus 102, the secure module 210 cancels the assignment of the third storage area. As a result, since the storage area storing a caller subroutine is released, the system 100 can reduce the amount of the storage area used of the information processing apparatus 102.

The secure module 210 may perform obfuscation according to an obfuscation mode randomly selected from multiple obfuscation modes at the time of the activation process and may cancel the obfuscation according to the randomly selected obfuscation mode at the time of the execution process. As a result, since the secure module 210 selects a different obfuscation mode for each subroutine, the system 100 can make hacking and cracking by a third party difficult.

If an execution request is made, the secure module 210 may again obfuscate the subroutine that corresponds to the execution request, according to an obfuscation mode randomly selected from multiple obfuscation modes. As a result, the system 100 changes the obfuscation mode for each execution and therefore, can make hacking and cracking by a third party difficult.

The secure module 210 may randomly determine the arrangement location of the executable subroutine 114. As a result, a third party cannot know which memory should be dumped and therefore, the system 100 can make hacking by the third party difficult. Even if a third party attempts to dump a subroutine, it is difficult to dump the executable subroutines without overlap and combine the subroutines into an operable copy.

The secure module 210 may convert a command for calling another subroutine into a command for notifying the secure module 210 of an execution request for another subroutine. As a result, the system 100 need not make a change in the information processing apparatus 102.

The secure module 210 may convert a command for returning to a subroutine into a command for notifying the secure module 210 of an execution request for a caller subroutine. As a result, the system 100 need not make a change in the information processing apparatus 102.

The secure module 210 may compare the digest information of the subroutine decrypted at the time of the activation process with the digest information of the subroutine at the time of the execution process and need not store the executable subroutine 114 into the third storage area 413 if the digest information is not identical. As a result, in the case of cracking by a third party, the system 100 can stop the given app that is to be protected.

If it is determined that an execution request for a subroutine has not been received within the predetermined time interval, the secure module 210 may discard an execution request received after the determination, without storing the executable subroutine 114 into the third storage area 413. As a result, if a break is made by a third party, the system 100 can stop the given app that is to be protected.

In the system according to a second embodiment, the process executed by the secure module 210 according to the first embodiment is executed by the information processing apparatus according to the second embodiment to achieve reduction in resources of the secure module according to the second embodiment. Portions identical to those described in the first embodiment are denoted by the same reference numerals used in the first embodiment and will not be described again.

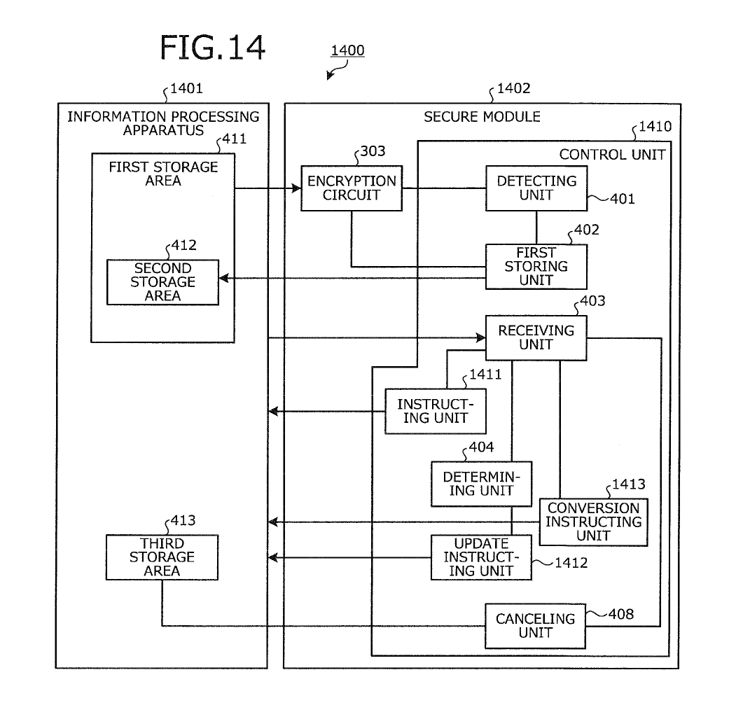

FIG. 14 is a block diagram of a functional configuration example of the secure module according to the second embodiment. A secure module 1402 is connected to an information processing apparatus 1401 included in a system 1400 according to the second embodiment and has the encryption circuit 303 and a control unit 1410. The control unit 1410 has the detecting unit 401 to the determining unit 404, the canceling unit 408, an instructing unit 1411, an update instructing unit 1412, and a conversion instructing unit 1413.

When the receiving unit 403 receives an execution request, the instructing unit 1411 instructs the information processing apparatus 1401 to cancel the obfuscation of the obfuscated subroutine 113 stored in the second storage area 412. The instruction contents include an obfuscation format selected by the first storing unit 402. The instructing unit 1411 gives an instruction for obfuscating and storing a subroutine that corresponds to the execution request, according to a newly randomly selected obfuscation format. The instruction contents are a newly randomly selected obfuscation format.

The update instructing unit 1412 instructs the information processing apparatus 1401 to update a command that uses a relative address or an absolute address, based on the address determined by the determining unit 404.

If the receiving unit 403 receives an execution request, the conversion instructing unit 1413 instructs the information processing apparatus 1401 to convert the following conversion source commands into conversion destination commands in the plain-text subroutine 112 that corresponds to the execution request. Two sets of the conversion source commands and the conversion destination commands exist and the conversion instructing unit 1413 gives an instruction to convert a first conversion source command into a first conversion destination command. The conversion instructing unit 1413 gives an instruction to convert a second conversion source command into a second conversion destination command.

The first conversion source command is a command for calling another subroutine different from the subroutine. The first conversion destination command is a command for notifying the secure module 1402 of an execution request for another subroutine. The second conversion source command is a command for returning to a subroutine that is a caller of a subroutine. The second conversion destination command is a command for notifying the secure module 1402 of an execution request for a subroutine that is a caller.

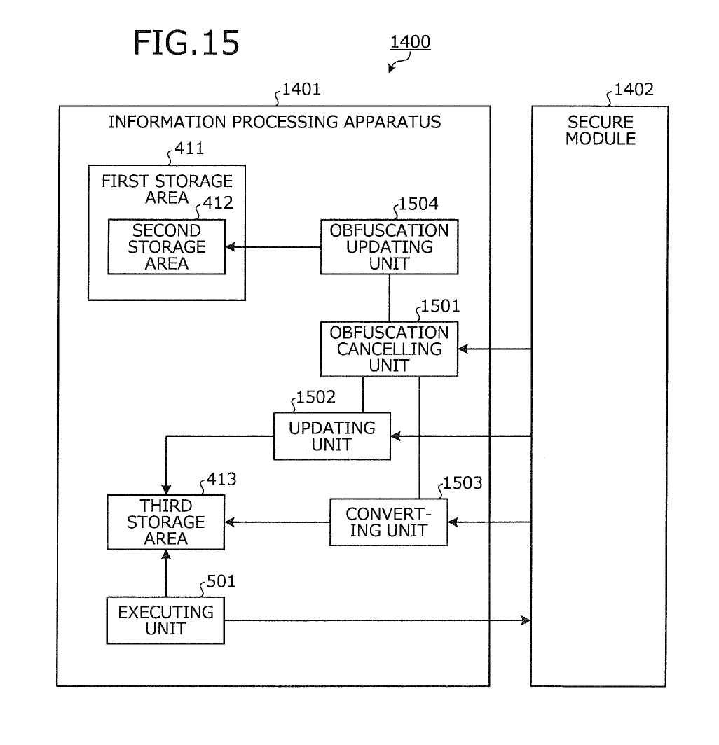

FIG. 15 is a block diagram of a functional configuration example of the information processing apparatus according to the second embodiment. The information processing apparatus 1401 has an obfuscation cancelling unit 1501, an updating unit 1502, a converting unit 1503, and an obfuscation updating unit 1504. With regard to the obfuscation cancelling unit 1501 to the obfuscation updating unit 1504, the functions of the obfuscation cancelling unit 1501 to the obfuscation updating unit 1504 are implemented by executing on the processor 201, a program stored in a storage device. For example, the storage device is the RAM 203 depicted in FIG. 2. The output results of the obfuscation cancelling unit 1501 to the obfuscation updating unit 1504 are stored to a storage area of the information processing apparatus 1401.

The obfuscation cancelling unit 1501 cancels the obfuscation of the obfuscated subroutine 113 that corresponds to the execution request, based on the instruction contents of the secure module 1402. Since the instruction contents include an obfuscation format selected by the first storing unit 402, the obfuscation cancelling unit 1501 cancels the obfuscation of the obfuscated subroutine 113 according to the selected obfuscation format.

If an instruction is received from the update instructing unit 1412 of the secure module 1402, the updating unit 1502 updates a command that uses a relative address or an absolute address, based on the address determined by the determining unit 404.

If an instruction is received from the conversion instructing unit 1413 of the secure module 1402, the converting unit 1503 converts a conversion source command into a conversion destination command in the plain-text subroutine 112 that corresponds to the execution request. The conversion source command and the conversion destination command have the same contents as described with reference to FIG. 14.

After the obfuscation cancelling unit 1501 cancels the obfuscation, the obfuscation updating unit 1504 gives an instruction to obfuscate and store the subroutine that corresponds to the execution request, according to a newly randomly selected obfuscation format included in the instruction contents of the secure module 1402.

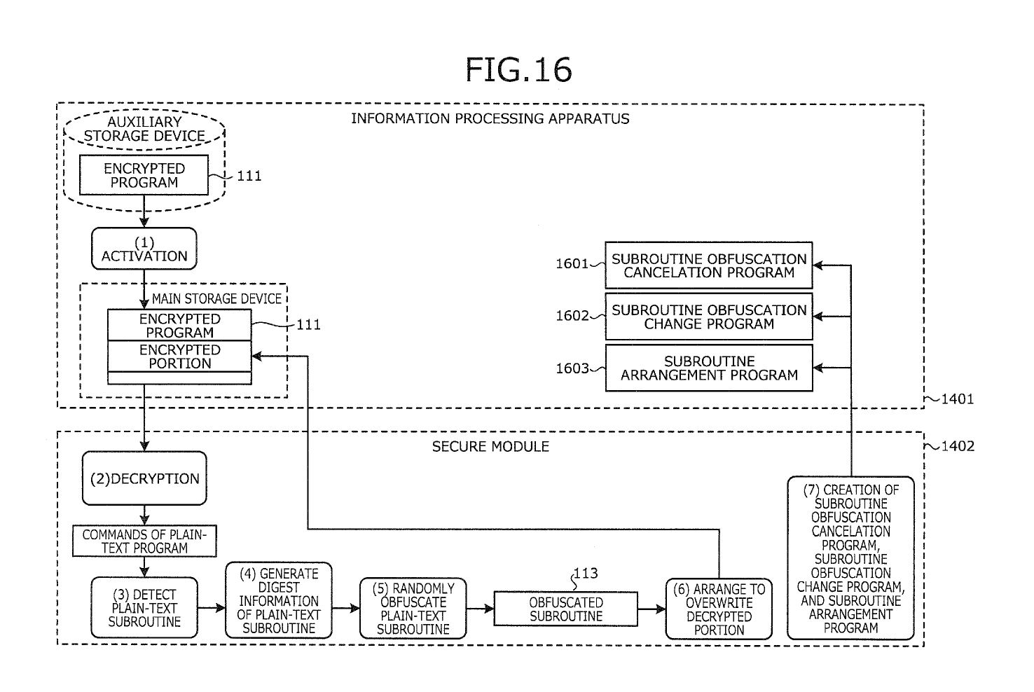

FIG. 16 is an explanatory view of an operation example of the activation process according to the second embodiment. It is noted that (1) of FIG. 16 to (6) of FIG. 16 are the same processes as the (1) of FIG. 8 to (6) of FIG. 8 and therefore, will not be described.

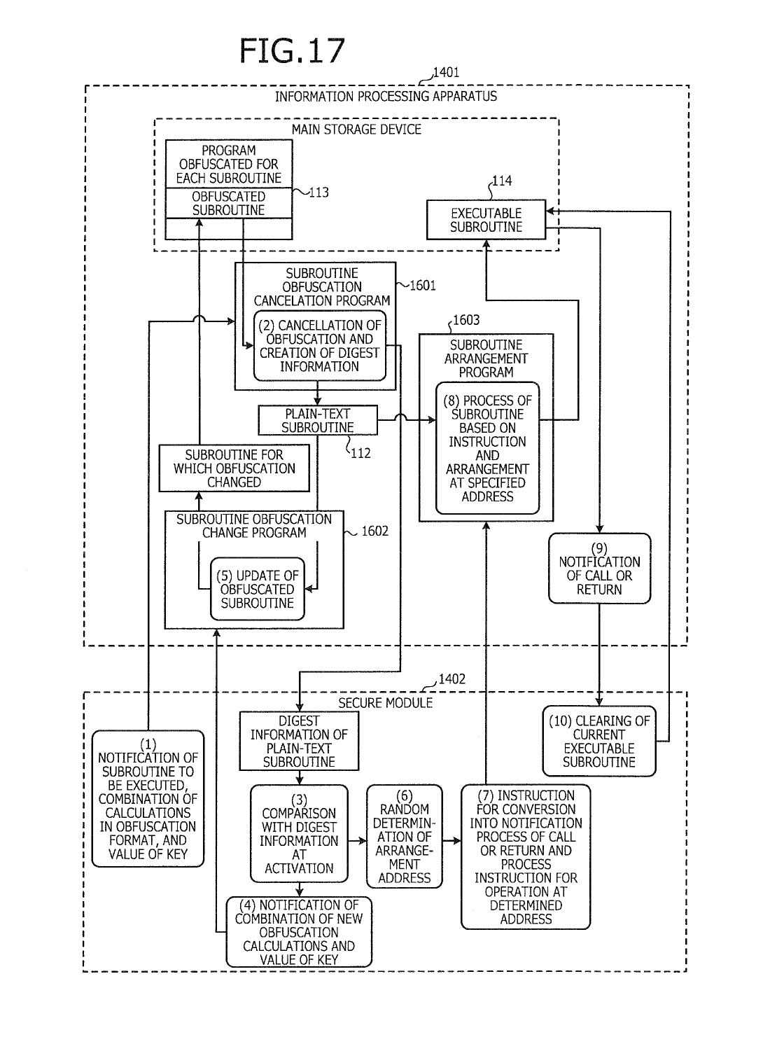

After completion of the obfuscation, at (7) of FIG. 16, the secure module 1402 creates a subroutine obfuscation cancelation program 1601, a subroutine obfuscation change program 1602, and a subroutine arrangement program 1603. The subroutine obfuscation cancelation program 1601 corresponds to the obfuscation cancelling unit 1501. The subroutine obfuscation change program 1602 corresponds to the obfuscation updating unit 1504. The subroutine arrangement program 1603 corresponds to the updating unit 1502 and the converting unit 1503. The operations of the subroutine obfuscation cancelation program 1601, the subroutine obfuscation change program 1602, and the subroutine arrangement program 1603 will be described with reference to FIG. 17.

FIG. 17 is an explanatory view of an operation example of the execution process according to the second embodiment. At (1) of FIG. 17, the secure module 1402 notifies the subroutine obfuscation cancelation program 1601 of a subroutine to be executed, a combination of calculations in the obfuscation format applied to the subroutine to be executed, and a value of a key.

At (2) of FIG. 17, the information processing apparatus 1401 executes the subroutine obfuscation cancelation program 1601 to cancel the obfuscation of the obfuscated subroutine 113 and obtain the plain-text subroutine 112, based on the instruction of the secure module 1402. The information processing apparatus 1401 executes the subroutine obfuscation cancelation program 1601 to generate the digest information of the plain-text subroutine 112 and notify the secure module 1402 of the digest information so as to detect tampering during operation.

At (3) of FIG. 17, the secure module 1402 receives the digest information of the plain-text subroutine 112 and makes a comparison to determine whether the received digest information is identical to the digest information stored in the activation process. If not identical, the secure module 1402 considers the obfuscated subroutine 113 to have been cracked, and does not execute the subsequent process.

At (4) of FIG. 17, the secure module 1402 notifies the subroutine obfuscation change program 1602 of a combination of the obfuscation calculations and a value of a key in an obfuscation format randomly selected from among multiple obfuscation formats.

At (5) of FIG. 17, the information processing apparatus 1401 executes the subroutine obfuscation change program 1602 to create the new obfuscated subroutine 113 and update the obfuscated subroutine 113 on the main storage apparatus, based on the instruction of the secure module 1402.

At (6) of FIG. 17, the secure module 1402 randomly determines an arrangement address of the converted plain-text subroutine 112, from a predetermined address range. At (7) of FIG. 17, the secure module 1402 notifies the subroutine arrangement program 1603 of an instruction to convert a call or a return into a process of notifying the secure module 1402 and a process instruction for operation at the determined address.

At (8) of FIG. 17, the information processing apparatus 1401 executes the subroutine arrangement program 1603 to convert the calling and returning processes into the processes of notifying a secure hardware module, based on the instruction of the secure module 1402. The information processing apparatus 1401 processes the subroutine for operation at the determined address and assigns the third storage area 413 at a specified address on the main storage device of the information processing apparatus 1401, based on the instruction of the secure module 1402. The information processing apparatus 1401 disposes the executable subroutine 114 that is made executable.

At (9) of FIG. 17, the information processing apparatus 1401 executes the executable subroutine 114 to notify the secure module 1402 of a change of a subroutine in association with calling or returning to another subroutine. In the case of calling another subroutine, the information processing apparatus 1401 also supplies the information of the “ID for specifying which calling process”.

At (10) of FIG. 17, the notified secure module 1402 clears the current subroutine in the main storage device of the information processing apparatus 1401. The information processing apparatus 1401 and the secure module 1402 repeats the operations from (1) of FIG. 17.

In the system 1400 according to the second embodiment, the subroutine obfuscation cancelation program 1601 to the subroutine arrangement program 1603 are arranged on the main storage device that can be easily accessed by a malicious user and malware. Therefore, the secure module 1402 may regularly make an update to different arrangement locations and different contents so as to make it difficult to hack and crack the subroutine obfuscation cancelation program 1601 to the subroutine arrangement program 1603.

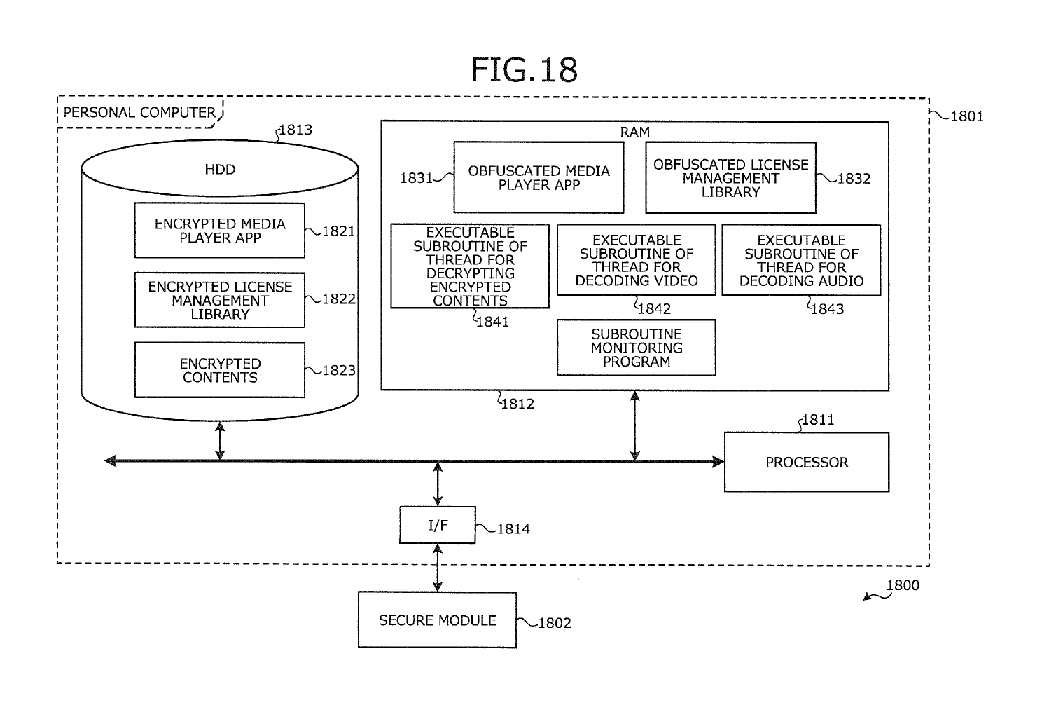

FIG. 18 is an explanatory view of an application example of the first or second embodiment. A computer system 1800 depicted in FIG. 18 is a system to which the system 100 according to the first embodiment or the system 1400 according to the second embodiment is applied. In the following description, the computer system 1800 is a system to which the system 100 according to the first embodiment is applied, for simplicity of the description.

The computer system 1800 has a personal computer (PC) 1801 and a secure module 1802. The PC 1801 corresponds to the information processing apparatus 102. The secure module 1802 corresponds to the secure module 210.

The PC 1801 has a processor 1811, RAM 1812, an HDD 1813, and an I/F 1814. The processor 1811 corresponds to the processor 201. The RAM 1812 corresponds to the RAM 203. The HDD 1813 corresponds to the HDD 207. The PC 1801 is connected through the I/F 1814 to the secure module 1802.

In FIG. 18, the given app that is to be protected is a media player app. The media player app is stored as an encrypted media player app 1821 in the HDD 1813.

The media player app operates by reading a license management library implementing a process of decrypting encrypted contents based on license information. The license management library is stored as an encrypted license management library 1822 in the HDD 1813.

The function of the media player app is to decrypt encrypted contents 1823 obtained by encrypting a compressed moving image and stored in the HDD 1813 and to decode the compressed moving image. The media player app realizes the function through parallel operations of three threads, i.e., a thread of obtaining and decrypting the encrypted contents 1823, a thread of decoding video of the decrypted compression moving image, and a thread of decoding audio of the compressed moving image.

To protect the media player app and the license management library, the PC 1801 uses the secure module 1802.

The secure module 1802 decrypts and then obfuscates the encrypted media player app 1821 and the encrypted license management library 1822 at the time of activation of the media player app. The obfuscated media player app 1831 and the obfuscated license management library 1832 are stored in the RAM 1812.

During operation of the media player app, the secure module 1802 arranges an executable subroutine for each thread executed in parallel. For example, the secure module 1802 arranges the following three executable subroutines. A first executable subroutine is an executable subroutine 1841 of a thread for decrypting the encrypted contents 1823. A second executable subroutine is an executable subroutine 1842 of a thread for decoding video. A third executable subroutine is an executable subroutine 1843 of a thread for decoding audio. The secure module 1802 arranges in the RAM 1812, one monitoring program that generates the executable subroutine 1841 to the executable subroutine 1843.

The secure module 210, 1402 described in the present embodiment can be realized by an application specific integrated circuit (ASIC) such as a standard cell or a structured ASIC, or a programmable logic device (PLD) such as a field-programmable gate array (FPGA). Specifically, for example, functional units (control unit 400, 1410) of the secure module 210, 1402 are defined in hardware description language (HDL), which is logically synthesized and applied to the ASIC, the PLD, etc., thereby enabling manufacture of the secure module 210, 1402.

One aspect of the embodiments produces an effect that the storage area used in the information processing apparatus can be reduced when the encrypted program is executed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for executing a program in a system that includes a decryption apparatus having a structure that prevents external referencing of information stored therein and an information processing apparatus configured to communicate with the decryption apparatus, the method comprising:
detecting, by the decryption apparatus, a series of commands from a command group obtained by decrypting at least a portion of an encrypted program stored in a first storage area, the first storage area being configured to be accessed by the information processing apparatus;
storing, by the decryption apparatus, obfuscated commands to a second storage area that stores a decrypted portion of the encrypted program and is within the first storage area, the obfuscated commands being obtained by obfuscating the detected series of commands;
assigning, by the decryption apparatus, when a first execution request of any one series of commands in the command group is received from the information processing apparatus, a third storage area that is different from the first storage area, the third storage area being configured to be accessed by the information processing apparatus and having a storage amount equivalent to the any one series of commands;
storing, by the decryption apparatus, to the assigned third storage area, a series of certain commands stored in the second area, the series of certain commands being obtained by canceling obfuscation of the obfuscated commands that correspond to the first execution request; and
executing, by the information processing unit, the series of the certain commands stored in the third storage area.

2. The method according to claim 1, comprising
canceling, by the decryption apparatus, assignment of the third storage area when an execution request for another series of commands that is different from the certain commands and that is called by the any one series of commands is received from the information processing apparatus.

3. The method according to claim 1, wherein
the storing to the second storage area includes storing to the second storage area, the obfuscated commands that are obtained by obfuscating the detected series of commands in accordance with a certain obfuscation format randomly selected from a plurality of obfuscation formats, and
the storing to the assigned third storage area includes storing to the third storage area, when the execution request is received from the information processing apparatus, the series of the certain commands that is obtained by canceling obfuscation of the obfuscated commands that correspond to the first execution request in accordance with the certain obfuscation format.

4. The method according to claim 3, further comprising
storing, by the decryption apparatus, to the second storage area, the obfuscated commands that correspond to the execution request and that accordance to the certain obfuscation format randomly selected from the plurality of obfuscation formats.

5. The method according to claim 1, comprising
randomly determining, by the decryption apparatus, an address of the third storage area from a first address range, when the execution request is received from the information processing apparatus, and
updating, by the decryption apparatus, based on the determined address, a command that uses a relative address or an absolute address and is among the series of certain commands, wherein
the storing to the assigned third storage area includes storing the updated command to the third storage area.

6. The method according to claim 1, comprising
converting, by the decryption apparatus, when the execution request is received from the information processing apparatus, a command for calling another series of commands different from the series of certain commands, into a command for notifying the decryption apparatus of an execution request for the another series of commands, wherein
the storing to the assigned third storage area includes storing the converted command to the third storage area.

7. The method according to claim 1, comprising
converting, by the decryption apparatus, when the first execution request is received from the information processing apparatus, a command for returning to a series of caller commands that is a caller of the series of certain commands, into a command for notifying the decryption apparatus of a second execution request for the series of caller commands, wherein
the storing to the assigned third storage area includes storing the converted command to the third storage area.

8. The method according to claim 1, comprising
retaining, by the decryption apparatus, digest information of the detected series of commands, and
determining, by the decryption apparatus, when the execution request is received from the information processing apparatus, whether digest information of the series of certain commands that are stored in the second storage area is identical to the retained digest information, wherein
the storing to the assigned third storage area includes not storing to the third storage area, the series of certain commands, when the digest information of the certain commands is determined to be not identical to the retained digest information.

9. The method according to claim 1, comprising
determining, by the decryption apparatus, whether the first execution request is received from the information processing apparatus before a first time interval has elapsed since a time when a second execution request for a caller command that is a caller of the series of certain commands is received from the information processing apparatus, wherein
the storing to the assigned third storage area includes not storing to the third storage area, the series of certain commands, when the first execution request is received from the information processing apparatus after the first execution request is determined to be not received from the information processing apparatus before the first time interval has elapsed.

10. A decryption apparatus configured to communicate with an information processing apparatus and having a structure that prevents external referencing of information stored therein, the apparatus comprising
a processor configured to:
detect a series of commands from a command group obtained by decrypting at least a portion of an encrypted program stored in a first storage area, the first storage area being configured to be accessed by the information processing apparatus;
store obfuscated commands to a second storage area that stores a decrypted portion of the encrypted program and is within the first storage area, the obfuscated commands being obtained by obfuscating the detected series of commands;
assign, when a first execution request of any one series of commands in the command group is received from the information processing apparatus, a third storage area that is different from the first storage area, the third storage area being configured to be accessed by the information processing apparatus and having a storage amount equivalent to the any one series of commands; and
store to the assigned third storage area, a series of certain commands stored in the second area, the series of certain commands being obtained by canceling obfuscation of the obfuscated commands that correspond to the first execution request.

11. The apparatus according to claim 10, wherein
the processor cancels assignment of the third storage area when an execution request for another series of commands that is different from the certain commands and that is called by the any one series of commands is received from the information processing apparatus.

12. The apparatus according to claim 10, wherein
the processor stores to the second storage area, the obfuscated commands that are obtained by obfuscating the detected series of commands in accordance with a certain obfuscation format randomly selected from a plurality of obfuscation formats, and
the processor stores to the third storage area, when the execution request is received from the information processing apparatus, the series of the certain commands that is obtained by canceling obfuscation of the obfuscated commands that correspond to the first execution request in accordance with the certain obfuscation format.

13. The apparatus according to claim 12, wherein
the processor is further configured store to the second storage area, the obfuscated commands that correspond to the execution request and that accordance to the certain obfuscation format randomly selected from the plurality of obfuscation formats.

14. The apparatus according to claim 10, wherein
the processor further configured to:
randomly determine an address of the third storage area from a first address range, when the execution request is received from the information processing apparatus, and
update based on the determined address, a command that uses a relative address or an absolute address and is among the series of certain commands, wherein
the processor stores the updated command to the third storage area.

15. The apparatus according to claim 10, wherein
the processor is further configured to convert, when the execution request is received from the information processing apparatus, a command for calling another series of commands different from the series of certain commands, into a command for notifying the decryption apparatus of an execution request for the another series of commands, and
the processor stores the converted command to the third storage area.

16. The apparatus according to claim 10, wherein
the processor is further configured to convert, when the first execution request is received from the information processing apparatus, a command for returning to a series of caller commands that is a caller of the series of certain commands, into a command for notifying the decryption apparatus of a second execution request for the series of caller commands, and
the processor stores the converted command to the third storage area.

17. The apparatus according to claim 10, wherein
the processor is further configured to:
retain digest information of the detected series of commands, and
determine, when the execution request is received from the information processing apparatus, whether digest information of the series of certain commands that are stored in the second storage area is identical to the retained digest information, wherein
the processor does not store to the third storage area, the series of certain commands, when the digest information of the certain commands is determined to be not identical to the retained digest information.

18. The apparatus according to claim 10, wherein
the processor is further configured to determine whether the first execution request is received from the information processing apparatus before a first time interval has elapsed since a time when a second execution request for a caller command that is a caller of the series of certain commands is received from the information processing apparatus, and
the processor does not store to the third storage area, the series of certain commands, when the first execution request is received from the information processing apparatus after the first execution request is determined to be not received from the information processing apparatus before the first time interval has elapsed.
